(19) United States
(12) Patent Application Publication
(10) Pub. No.: US 2024/0297345 A1
(43) Pub. Date: Sep. 5, 2024

(54) PREPARATION OF LITHIUM BIS(FLUOROSULFONYL)IMIDE, AND APPLICATION THEREOF

(71) Applicant: SHENZHEN YANYI NEW MATERIALS CO., LTD., Shenzhen, Guangdong (CN)

(72) Inventors: Min YUE, Shenzhen, Guangdong (CN); Yi YU, Shenzhen, Guangdong (CN); Xianbing HU, Quzhou City, Zhejiang Province (CN)

(21) Appl. No.: 18/565,069

(22) PCT Filed: Nov. 5, 2021
(86) PCT No.: PCT/CN2021/129083

§ 371 Date: Nov. 28, 2023

(30) Foreign Application Priority Data
Jun. 17, 2021 (CN) 202110670267.1

(51) Int. Cl. H01M 10/0568; B01D 19/00; C01B 21/086; C01B 25/455; H01M 10/0525

(52) U.S. Cl. CPC H01M 10/0568; B01D 19/0005; C01B 21/086; C01B 25/455; H01M 10/0525; C01P 2006/40; C01P 2006/82; H01M 2300/0025

(57) ABSTRACT

A lithium bis(fluorosulfonyl)imide, a preparation method therefor and an application thereof, wherein iminodisulfonic acid is synthesized by using sulfur trioxide and ammonia as raw materials, the iminodisulfonic acid is chlorinated by means of thionyl chloride to obtain bis(chlorosulfonyl)imide, and then fluorination and lithiation are performed in sequence to obtain the lithium bis(fluorosulfonyl)imide. The method has excellent yield and purity; and compared with a traditional process, the method has the advantages of simple raw materials, less generation of three wastes, green environmental protection, fewer side reactions, low cost and the like, and is easy to industrialize.

### TECHNICAL FIELD

The present invention is in the technical field of chemical synthesis, and more particularly, it relates to a lithium bis(fluorosulfonyl)imide and a preparation method and application thereof.

### BACKGROUND ART

In recent years, driven by smartphones, mobile power supplies, tablet computers, and other products, domestic lithium battery industry output continues to grow. At the same time, the applications of lithium-ion batteries are no longer limited to electronic consumer products, and two new directions of power and energy storage bring unlimited market space for lithium batteries. As the application fields expand, the demand for further improvement of the battery also increases. At present, the most widely used electrolyte lithium salt is lithium hexafluorophosphate. Although lithium hexafluorophosphate has good comprehensive properties, it also has shortcomings, such as instability, easy water absorption, short life, poor low-temperature performance, and so on, which make it insufficient to meet the growing application requirements of lithium-ion batteries.

Compared with lithium hexafluorophosphate, lithium bis(fluorosulfonyl)imide (LiFSI) has better thermal stability, chemical stability, higher electrical conductivity, and lower corrosion rate, and is considered a possible replacement for lithium hexafluorophosphate to be a new generation of lithium salt, which can be widely used in lithium batteries and supercapacitors. As an electrolyte for a lithium-ion secondary battery, it is required to meet stringent requirements such as high purity and no water content. When the moisture is introduced, it is difficult to completely remove the water by drying and removing the water until it decomposes by heating the water. In the past, when generating the first step intermediate bis(chlorosulfonyl)imide, the highly corrosive raw materials, such as chlorosulfonic acid, sulfamic acid, and thionyl chloride were mostly used to synthesize bis(chlorosulfonyl)imide, resulting in low yield and many impurities, which has a great impact on the environment.

CN101747242B discloses that bis(chlorosulfonyl)imide is obtained by reacting a sulfonamide with thionyl chloride and chlorosulfonic acid, then antimony trifluoride and potassium carbonate (cesium or rubidium) are reacted to obtain potassium bis(fluorosulfonyl)imide (cesium or rubidium), and finally, potassium bis(fluorosulfonyl)imide (cesium or rubidium) and lithium perchlorate or lithium tetrafluoroborate are subjected to a metathesis reaction to obtain lithium bis(fluorosulfonyl)imide, with a complicated process and a low yield.

CN107265419A discloses a method for producing lithium bis (fluorosulfonyl) imide or sodium bis (fluorosulfonyl) imide, wherein sulfamic acid and halosulfonic acid are reacted with triethylamine to produce bis (sulfonyl) imide, then potassium hydroxide is added to produce potassium bis (sulfonyl) imide trisalt, then oxalyl chloride is added to produce potassium bis (chlorosulfonyl) imide, and finally hydrogen fluoride is added to obtain golden yellow bis (fluorosulfonyl) imide, the process is relatively complicated, and no data on yield and purity are given.

licated, and no data on yield and purity are given.

KR102223112B1 discloses a preparation method for fluorosulfonimide potassium salt, wherein iminodisulfonic acid is produced by reacting chlorosulfonic acid with ammonia, nitrosyl fluoride is used to fluorinate the same to produce bis(fluorosulfonyl)imide, and then lithium hydroxide is added to produce lithium bis(fluorosulfonyl)imide; since nitrosyl fluoride is unstable, toluene solvent and the like need to be used, using lithium hydroxide in the lithiation process will produce moisture, resulting in low purity of the reaction product.

rity of the reaction product.

U.S. Pat. No. 5,916,475A discloses the use of fluorosulfonic acid and urea to react to produce bis-fluorosulfonimide, followed by lithiation to obtain lithium bis(fluorosulfonyl)imide. All operations need to be carried out in hydrofluoric acid-resistant plants, with large investment in equipment and high operating risk.

WO2009123328A1 discloses the preparation of bis(chlorosulfonyl)imide using cyanogen chloride and sulfur trioxide to form chlorosulfonic acid isocyanate and then reacting with chlorosulfonic acid. Cyanogen chloride is a highly toxic gas and has a great impact on a safe environment.

n chloride is a highly toxic gas and has a great impact on a safe environment.

US20120245386A1 discloses the reaction of SO₂F₂ and NH₃ as raw materials, tetramethylenediamine (TMPDA) as a base, acetonitrile as a solvent at 10 to 15° C. After completion of the reaction, the low boiling point liquid is separated under reduced pressure, the viscous product is dissolved in methanol at 30° C., and one equivalent of tetrabutylammonium bromide aqueous solution is added dropwise to the methanol solution, then a white solid precipitates and tetrabutylammonium bis(fluorosulfonyl)imide metal salt is obtained in a yield of 84.4% after filtration. SO₂F₂ is highly toxic, completely colorless, and odorless, and significant precautions must be taken.

WO2010140580A1 discloses the direct formation of bis(fluorosulfonyl)imide metal salts by reacting SO₂F₂ with ammonia and 6 equivalents of a fluoride salt by heating to 60° C. SO₂F₂ is also highly toxic, completely colorless, and odorless, and significant precautions must be taken.

WO2010113835A1 discloses that the molar ratio of SO₂F₂, NH₃, and Et₃N is 2:1:3, acetonitrile is a solvent, and triethylamine bis(fluorosulfonyl)imide metal salt and a small amount of by-products are obtained in a yield of more than 90% under an ice-water bath. Various metal hydroxides are slowly added to the triethylamine bis(fluorosulfonyl)imide metal salt solution, and triethylamine is removed to obtain the product bis(fluorosulfonyl)imide metal salt. Bis(fluorosulfonyl)imide triethylamine salt was effectively synthesized by using SO₂F₂, NH₃, and Et₃N as cheap starting materials, and this salt has excellent ion exchange capacity and can be exchanged efficiently to obtain bis(fluorosulfonyl)imide metal salt. However, in this reaction, excess triethylamine will cause SO₂F₂ to generate the hydrolysis product triethylamine fluorosulfonate and other by-products. When this method is used directly to prepare lithium bis(fluorosulfonyl)imide, the cost of post-purification treatment is high. In addition, sulfonyl fluorides are expensive, difficult to prepare, highly toxic, highly corrosive, and have a great impact on the safe environment.

### SUMMARY OF THE INVENTION

The technical problem to be solved by the present invention is: in the preparation of lithium bis(fluorosulfonyl)imide in the prior art, the raw materials used are highly toxic, highly corrosive, with high production cost, low yield, and purity, and have a large environmental impact.

In view of the deficiencies of the prior art, one of the objectives of the present invention is to provide a preparation method for lithium bis(fluorosulfonyl)imide, which uses a simple raw material, has a low preparation cost, generates less waste gas, has a little environmental impact, a high reaction yield and a high product purity, which is easy to industrialize; another object of the present invention is to provide a lithium bis(fluorosulfonyl)imide prepared by the above-mentioned preparation method; a third object of the present invention is to provide a lithium bis(fluorosulfonyl)imide prepared by the above-mentioned preparation method or the use of the above-mentioned lithium bis(fluorosulfonyl)imide in a lithium-ion battery.

The technical solution of the present invention is as follows:

The present invention provides a preparation method for bisfluorosulfonamide, comprising the following steps of:
(1) reacting sulfur trioxide and ammonia in a high-pressure reaction kettle to obtain iminodisulfonic acid, wherein the reaction pressure is 0.8 to 1.5 Mpa;
(2) reacting thionyl chloride with the iminodisulfonic acid obtained in step (1) to obtain bis(chlorosulfonyl)imide by vacuum distillation;
(3) reacting the bis(chlorosulfonyl)imide obtained in step (2) with hydrogen fluoride to obtain bis(fluorosulfonyl)imide by vacuum distillation;
(4) reacting the bis(fluorosulfonyl)imide obtained in step (3) with lithium fluoride to obtain lithium bis(fluorosulfonyl)imide by solid-liquid separation, purification, and drying.

Preferably, in the above preparation method, in step (1), the molar ratio of ammonia to sulfur trioxide is 1:2-3.

Preferably, in the above preparation method, in step (1), the reaction pressure is 0.8 to 1.0 MPa, preferably, the reaction temperature is 20 to 30° C., and further preferably, the reaction time is 4 to 6 h.

Preferably, in the above preparation method, in step (2), the reaction temperature is 80 to 100° C., and preferably, the reaction time is 12 to 16 h.

Preferably, in the above preparation method, in step (2), the molar ratio of iminodisulfonic acid to thionyl chloride is 1:2.0-2.5, preferably 1:2.2-2.5.

Preferably, in the above preparation method, in step (3), the molar ratio of bis(chlorosulfonyl)imide to hydrogen fluoride is 1:2.0-3.0.

Preferably, in the above preparation method, in step (3), the reaction temperature is 80 to 150° C., preferably 90 to 120° C., and preferably the reaction time is 14 to 20 h.

Preferably, in the above preparation method, in step (4), the molar ratio of bis(fluorosulfonyl)imide to lithium fluoride is 1:0.85-1.00.

Preferably, in the above preparation method, in step (4), the reaction temperature is 120° C. to 160° C., and preferably, the reaction time is 30 to 60 min.

The present invention also provides lithium bis(fluorosulfonyl)imide having a purity of ≥99.6% obtained by the above preparation method.

The present invention also provides a lithium bis(fluorosulfonyl)imide prepared by the above-mentioned preparation method or the use of the above-mentioned lithium bis(fluorosulfonyl)imide in a lithium-ion battery.

The present invention also provides a preparation method for bis(chlorosulfonyl)imide, comprising the following steps of:
(1) reacting sulfur trioxide and ammonia in a high-pressure reaction kettle to obtain iminodisulfonic acid, wherein the reaction pressure is 0.8 to 1.5 Mpa;
(2) reacting thionyl chloride with the iminodisulfonic acid obtained in step (1) to obtain bis(chlorosulfonyl)imide by vacuum distillation.

The advantageous effects of the present invention are as follows:
in the present invention, iminodisulfonic acid is prepared using sulfur trioxide and ammonia as raw materials, bis(chlorosulfonyl)imide is obtained by chlorination of thionyl chloride, and then lithium bis(fluorosulfonyl)imide is prepared by fluorination and lithiation successively, using simple raw materials and low preparation cost; less waste, less corrosivity, and green process; which has fewer side reactions, excellent yield, and high purity, and can meet the requirements of yield and quality for large-scale industrial production.
scale industrial production.

### DETAILED DESCRIPTION OF THE INVENTION

In order to better understand the above-mentioned technical solutions, the technical solutions of the present application are described in detail through specific embodiments below, and it should be understood that the embodiments and the specific features in the embodiments of the present application are a detailed description of the technical solutions of the present application rather than a limitation of the technical solutions of the present application; and the embodiments and the technical features in the embodiments of the present application can be combined with each other without conflict.

The preparation method for lithium bis(fluorosulfonyl)imide provided by the present invention is a four-step reaction method, and the corresponding chemical reaction formula thereof is as follows:

2SO₃+NH₃→HN(SO₃H)₂

HN(SO₃H)₂+2SOCl₂═HN(SO₂Cl)₂+2HCl↑+2SO₂↑

HN(SO₂Cl)₂+2HF→HN(SO₂F)₂+2HCl↑

HN(SO₂F)₂+LiF→LIN(SO₂F)₂+HF↑

The present invention provides a preparation method for lithium bis(fluorosulfonyl)imide.

In a preferred embodiment of the invention, in particular, the preparation method comprises the following steps:
(1) reacting sulfur trioxide and ammonia in a high-pressure reaction kettle to obtain iminodisulfonic acid, wherein the reaction pressure is 0.8 to 1.5 Mpa;
(2) reacting thionyl chloride with the iminodisulfonic acid obtained in step (1) to obtain bis(chlorosulfonyl)imide by vacuum distillation;
(3) reacting the bis(chlorosulfonyl)imide obtained in step (2) with hydrogen fluoride to obtain bis(fluorosulfonyl)imide by vacuum distillation;
(4) reacting the bis(fluorosulfonyl)imide obtained in step (3) with lithium fluoride to obtain lithium bis(fluorosulfonyl)imide by solid-liquid separation, purification, and drying.

In step (1), the molar ratio of ammonia to sulfur trioxide is 1:2-3. The ammonia is allowed to react completely with an excess of sulfur trioxide to avoid further reaction with iminodisulfonic acid with an excess of ammonia to form unwanted by-products. When the reaction pressure is 0.8 to 1.5 MPa, when the pressure is lower than 0.8 MPa, the ammonia cannot be liquefied, which makes it difficult to carry out the reaction; when the pressure is higher than 1.5 MPa, there is no obvious difference in the yield and reaction rate of the reaction, and great safety risk is brought; preferably, the reaction pressure is 0.8 to 1.0 MPa; further preferably, the reaction temperature is 20 to 30° C.; when the reaction temperature is lower than 20° C., the reaction rate slows down and the reaction yield decreases; when the reaction temperature is higher than 30° C., higher pressure is required to liquefy the ammonia; further preferably, the reaction time is 4 to 6 h.

Step (1) is carried out in a high-pressure reaction kettle, and in the specific operation, sulfur trioxide is firstly added into the reaction kettle, then ammonia is introduced into the reaction kettle, and nitrogen is used for pressurization; after the reaction is finished, nitrogen is released for pressure relief, and the temperature is raised to 80° C. to remove unreacted sulfur trioxide, so as to obtain iminodisulfonic acid.

In step (2), the reaction temperature is 80 to 100° C., and preferably, the reaction time is 12 to 16 h. The molar ratio of iminodisulfonic acid to thionyl chloride is 1:2.0-2.5, preferably 1:2.2-2.5. In this reaction, 1 equivalent of iminodisulfonic acid is reacted with 2 equivalents of thionyl chloride. Since the reaction temperature is higher, part of thionyl chloride will be lost in the reflux process. Therefore, the minimum amount of thionyl chloride used is generally 2.2 equivalents. The reaction yield and reaction rate are not significantly affected by the amount of thionyl chloride higher than 2.5 equivalents. After the reaction is completed, the reaction product is subjected to vacuum distillation at 120 to 130° C. for 3 to 5 h, and the vacuum degree of the vacuum distillation is −0.05 MPa to −0.09 MPa to obtain bis(chlorosulfonyl)imide.

de higher than 2.5 equivalents. After the reaction is completed, the reaction product is subjected to vacuum distillation at 120 to 130° C. for 3 to 5 h, and the vacuum degree of the vacuum distillation is −0.05 MPa to −0.09 MPa to obtain bis(chlorosulfonyl)imide.

In step (3), the molar ratio of bis(chlorosulfonyl)imide to hydrogen fluoride is 1:2.0-3.0. The reaction temperature is from 80 to 150° C., preferably from 90 to 120° C., preferably the reaction time is from 14 to 20 h. After completion of the reaction, nitrogen was blown through the system for 4 h to remove generated hydrogen chloride gas and unreacted hydrogen fluoride gas.

, nitrogen was blown through the system for 4 h to remove generated hydrogen chloride gas and unreacted hydrogen fluoride gas.

Step (3) the vacuum distillation is performed at 90 to 110° C., the vacuum degree of the vacuum distillation is −0.05 MPa to −0.09 MPa, the time of the vacuum distillation is 2 to 3 h, the fraction obtained by the vacuum distillation is bis(fluorosulfonyl)imide, and the distillation residue participates in the next preparation reaction of bis(fluorosulfonyl)imide.

In step (4), the molar ratio of bis(fluorosulfonyl)imide to lithium fluoride is 1:0.85-1.00. In this reaction, since post-treatment of lithium fluoride is difficult and the lithium fluoride remaining is difficult to remove, it is preferable to complete the lithium fluoride reaction. The reaction temperature is from 120° C. to 160° C., preferably the reaction time is from 30 to 60 minutes; after the reaction is completed, blowing nitrogen into the system for 1 h to remove the generated hydrogen fluoride gas, and then purifying and drying the obtained lithium bis(fluorosulfonyl)imide to obtain lithium bis(fluorosulfonyl)imide; the purification comprises washing the reaction product with dichloromethane, removing the residual bis-fluorosulfonimide, then dissolving with diethyl ether, filtering to remove impurities, then concentrating by evaporation, adding an organic solvent to recrystallize the concentrated solution, and finally drying to obtain lithium bis(fluorosulfonyl)imide.

concentrated solution, and finally drying to obtain lithium bis(fluorosulfonyl)imide.

The lithium bis(fluorosulfonyl)imide prepared by the preparation method for the present invention has a purity of ≥99.6%.

The present invention also provides a lithium bis(fluorosulfonyl)imide prepared by the above-mentioned preparation method or the use of the above-mentioned lithium bis(fluorosulfonyl)imide in a lithium-ion battery.

The present invention also provides a preparation method for bis(chlorosulfonyl)imide, comprising the following steps of:
(1) reacting sulfur trioxide and ammonia in a high-pressure reaction kettle to obtain iminodisulfonic acid, wherein the reaction pressure is 0.8 to 1.5 Mpa;
(2) reacting thionyl chloride with the iminodisulfonic acid obtained in step (1) to obtain bis(chlorosulfonyl)imide by vacuum distillation.

### EXAMPLES

The raw materials or reagents used in the present invention are commercially available from mainstream manufacturers, manufacturers not specified, or concentrations not specified, and are analytically pure raw materials or reagents that can be conventionally obtained, provided that they can perform the intended function, without particular limitation. The instruments and equipment used in this example are all purchased from major commercial manufacturers and are not particularly limited as long as they can perform the intended functions. Where no specific techniques or conditions are specified in the examples, they are performed according to the techniques or conditions described in the literature in the field or according to the product description.

perform the intended functions. Where no specific techniques or conditions are specified in the examples, they are performed according to the techniques or conditions described in the literature in the field or according to the product description.

### Instruments:

High-pressure reaction kettle, 2 L high-pressure reaction kettle from Weihai Global Chemical Machinery MFG. Co. Ltd. was used;
Ion chromatography, Metrohm 833 ion chromatograph was used;
Nuclear magnetic resonance analyzer, AVANCE-400 from Bruker, Germany was used.

### Example 1

(1) 160.0 g of sulfur trioxide (molecular weight: 80.06 g/mol) was added into a high-pressure reaction kettle, the temperature was controlled at 25° C., 17.0 g of ammonia (molecular weight: 17.03 g/mol) was introduced into the high-pressure reaction kettle, then introducing nitrogen until the pressure in the high-pressure reaction kettle was 0.8 Mpa, reacting at 20° C. for 6 h, after the reaction was completed, the nitrogen in the high-pressure reaction kettle was released, and heating to 80° C. to remove the remaining sulfur trioxide to obtain 165.3 g of the product, which is identified by 1H-NMR spectrum as iminodisulfonic acid (molecular weight: 177.15 g/mol), the 1H-NMR spectrum of the iminodisulfonic acid was as follows: 1H-NMR (400M, DMSO-d6):δ:4.31 (s, 2H), 8:6.91 (s, 1H).
(2) 165.3 g of iminodisulfonic acid obtained in step (1) was added into a reactor, heated to 80° C., 245.1 g of thionyl chloride (molecular weight: 118.97 g/mol) was slowly added dropwise thereto, the tail gas generated in the reaction was absorbed by an alkaline solution of potassium hydroxide, the reaction was stirred for 12 h and then cooled to room temperature, and the mixture was subjected to vacuum distillation under a vacuum degree of −0.05 MPa at 120° C. for 5 h to obtain 180.5 g of a product which was identified as bis(chlorosulfonyl)imide (molecular weight: 214.03 g/mol) according to the 1H-NMR spectrum.
(3) 180.5 g of the bis(chlorosulfonyl)imide obtained in step (2) was added into a reactor, heated to 80° C., 33.8 g of HF (molecular weight 20.01 g/mol) gas was slowly introduced, the mixture was reacted for 14 h and then lowered to room temperature, nitrogen was blown into the reactor for 4 h, and then vacuum distillation was performed at −0.05 MPa at 90° C. for 3 h to obtain 126.8 g of bis(fluorosulfonyl)imide (molecular weight 181.13 g/mol).
(4) 18.15 g of lithium fluoride (molecular weight 25.94 g/mol) was added into a reactor, heated to 120° C., and 126.8 g of the bis(fluorosulfonyl)imide obtained in step (3) was slowly added dropwise. After reacting for 30 min, nitrogen was blown into the reactor for 1 h, the temperature was lowered to room temperature, the filter cake obtained by filtration was washed with dichloromethane, then the filter cake was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 117.8 g of lithium bis(fluorosulfonyl)imide (molecular weight 187.07 g/mol). The purity of lithium bis(fluorosulfonyl)imide was determined by using Metrohm 833 ion chromatograph.

The test results of relevant parameters are shown in Table 1.

### Example 2

(1) 239 g of sulfur trioxide was added into a high-pressure reaction kettle, the temperature was controlled at 25° C., 17.0 g of ammonia was introduced into the high-pressure reaction kettle, then introducing nitrogen until the pressure in the high-pressure reaction kettle was 1.0 Mpa, reacting at 30° C. for 5 h, after the reaction was completed, the nitrogen in the high-pressure reaction kettle was released, and heating to 80° C. to remove the remaining sulfur trioxide to obtain 168.3 g of the product, which is identified by 1H-NMR spectrum as iminodisulfonic acid, the 1H-NMR spectrum of the iminodisulfonic acid was as follows: 1H-NMR (400M, DMSO-d6):δ:4.31 (s, 2H), 8:6.91 (s, 1H).
(2) 168.3 g of iminodisulfonic acid obtained in step (1) was added into a reactor, heated to 100° C., 282 g of thionyl chloride was slowly added dropwise thereto, the tail gas generated in the reaction was absorbed by an alkaline solution of potassium hydroxide, the reaction was stirred for 16 h and then cooled to room temperature, and the mixture was subjected to vacuum distillation under a vacuum degree of −0.09 MPa at 130° C. for 3 h to obtain 189.8 g of a product which was identified as bis(chlorosulfonyl)imide according to the 1H-NMR spectrum.
(3) 189.8 g of the bis(chlorosulfonyl)imide obtained in step (2) was added into a reactor, heated to 90° C., 53 g of HF gas was slowly introduced, the mixture was reacted for 20 h and then lowered to room temperature, nitrogen was blown into the reactor for 4 h, and then vacuum distillation was performed at −0.09 MPa at 110° C. for 2 h to obtain 141.8 g of bis(fluorosulfonyl)imide.
(4) 17.28 g of lithium fluoride was added into a reactor, heated to 160° C., and 141.8 g of the bis(fluorosulfonyl)imide obtained in step (3) was slowly added dropwise. After reacting for 60 min, nitrogen was blown into the reactor for 1 h, the temperature was lowered to room temperature, then the reaction product was washed with dichloromethane, the filter cake obtained by filtration was washed with dichloromethane, then the filter cake was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 115.05 g of lithium bis(fluorosulfonyl)imide. The purity of lithium bis(fluorosulfonyl)imide was determined by using Metrohm 833 ion chromatograph.

The test results of relevant parameters are shown in Table 1.

### Example 3

(1) 200.2 g of sulfur trioxide was added into a high-pressure reaction kettle, the temperature was controlled at 25° C., 17.0 g of ammonia was introduced into the high-pressure reaction kettle, then introducing nitrogen until the pressure in the high-pressure reaction kettle was 0.9 Mpa, reacting at 25° C. for 6 h, after the reaction was completed, the nitrogen in the high-pressure reaction kettle was released, and heating to 80° C. to remove the remaining sulfur trioxide to obtain 166.7 g of the product, which is identified by 1H-NMR spectrum as iminodisulfonic acid, the 1H-NMR spectrum of the iminodisulfonic acid was as follows: 1H-NMR (400M, DMSO-d6):δ:4.31 (s, 2H), 8:6.91 (s, 1H).
(2) 166.7 g of iminodisulfonic acid obtained in step (1) was added into a reactor, heated to 90° C., 268.9 g of thionyl chloride was slowly added dropwise thereto, the tail gas generated in the reaction was absorbed by an alkaline solution of potassium hydroxide, the reaction was stirred for 14 h and then cooled to room temperature, and the mixture was subjected to vacuum distillation under a vacuum degree of −0.05 MPa at 125° C. for 4 h to obtain 186.2 g of a product which was identified as bis(chlorosulfonyl)imide according to the 1H-NMR spectrum.
(3) 186.2 g of the bis(chlorosulfonyl)imide obtained in step (2) was added into a reactor, heated to 100° C., 43.52 g of HF gas was slowly introduced, the mixture was reacted for 16 h and then lowered to room temperature, nitrogen was blown into the reactor for 4 h, and then vacuum distillation was performed at −0.05 MPa at 100° C. for 3 h to obtain 134.4 g of bis(fluorosulfonyl)imide.
(4) 17.3 g of lithium fluoride was added into a reactor, heated to 140° C., and 134.4 g of the bis(fluorosulfonyl)imide obtained in step (3) was slowly added dropwise. After reacting for 45 min, nitrogen was blown into the reactor for 1 h, the temperature was lowered to room temperature, then the reaction product was washed with dichloromethane, the filter cake obtained by filtration was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 114.1 g of lithium bis(fluorosulfonyl)imide. The purity of lithium bis(fluorosulfonyl)imide was determined by using Metrohm 833 ion chromatograph.

The test results of relevant parameters are shown in Table 1.

### Example 4

(1) 183.8 g of sulfur trioxide was added into a high-pressure reaction kettle, the temperature was controlled at 25° C., 17.0 g of ammonia was introduced into the high-pressure reaction kettle, then introducing nitrogen until the pressure in the high-pressure reaction kettle was 1.5 Mpa, reacting at 30° C. for 4 h, after the reaction was completed, the nitrogen in the high-pressure reaction kettle was released, and heating to 80° C. to remove the remaining sulfur trioxide to obtain 164.9 g of the product, which is identified by 1H-NMR spectrum as iminodisulfonic acid, the 1H-NMR spectrum of the iminodisulfonic acid was as follows: 1H-NMR (400M, DMSO-d6):δ:4.31 (s, 2H), 8:6.91 (s, 1H).
(2) 164.9 g of iminodisulfonic acid obtained in step (1) was added into a reactor, heated to 90° C., 222.63 g of thionyl chloride was slowly added dropwise thereto, the tail gas generated in the reaction was absorbed by an alkaline solution of potassium hydroxide, the reaction was stirred for 13 h and then cooled to room temperature, and the mixture was subjected to vacuum distillation under a vacuum degree of −0.05 MPa at 125° C. for 4 h to obtain 181.73 g of a product which was identified as bis(chlorosulfonyl)imide according to the 1H-NMR spectrum.
(3) 181.73 g of the bis(chlorosulfonyl)imide obtained in step (2) was added into a reactor, heated to 150° C., 47.57 g of HF gas was slowly introduced, the mixture was reacted for 18 h and then lowered to room temperature, nitrogen was blown into the reactor for 4 h, and then vacuum distillation was performed at −0.05 MPa at 100° C. for 3 h to obtain 127.96 g of bis(fluorosulfonyl)imide.
(4) 17.41 g of lithium fluoride was added into a reactor, heated to 150° C., and 127.96 g of the bis(fluorosulfonyl)imide obtained in step (3) was slowly added dropwise. After reacting for 40 min, nitrogen was blown into the reactor for 1 h, the temperature was lowered to room temperature, the filter cake obtained by filtration was washed with dichloromethane, then the filter cake was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 115.0 g of lithium bis(fluorosulfonyl)imide. The purity of lithium bis(fluorosulfonyl)imide was determined by using Metrohm 833 ion chromatograph.

n vacuum to obtain 115.0 g of lithium bis(fluorosulfonyl)imide. The purity of lithium bis(fluorosulfonyl)imide was determined by using Metrohm 833 ion chromatograph.

The test results of relevant parameters are shown in Table 1.

### Comparative Example 1

(1) 97.09 g of sulfamic acid (97.09 g/mol), 116.53 g of chlorosulfonic acid (molecular weight: 116.53 g/mol), and 261.7 g of thionyl chloride were successively added into a reactor and heated to 130° C. for 24 h. After completion of the reaction, low boiling point compounds were distilled off under normal pressure, followed by vacuum distillation. A fraction at 112 to 114° C./2 mmHg was collected and cooled to room temperature to obtain 175.1 g of bis(chlorosulfonyl)imide. The reaction equation is as follows:
ation is as follows:

NH₂SO₃H+CISO₃H+2SOCl₂→Cl₂HNO₄S₂+3HCl↑+SO₂|
(2) 175.1 g of the bis(chlorosulfonyl)imide obtained in step (1) was added into a reactor, heated to 80° C., 32.78 g of HF gas was slowly introduced, the mixture was reacted for 14 h and then lowered to room temperature, nitrogen was blown into the reactor for 4 h, and then vacuum distillation was performed at −0.05 MPa at 90° C. for 3 h to obtain 120.20 g of bis(fluorosulfonyl)imide.
(3) 5.0 g of lithium fluoride was added into a reactor, heated to 120° C., and 34.91 g of the bis(fluorosulfonyl)imide obtained in step (2) was slowly added dropwise. After reacting for 30 min, nitrogen was blown into the reactor for 1 h, the temperature was lowered to room temperature, then the reaction product was washed with dichloromethane, the filter cake obtained by filtration was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 31.92 g of lithium bis(fluorosulfonyl)imide. The purity of lithium bis(fluorosulfonyl)imide was determined by using Metrohm 833 ion chromatograph.

The purity of lithium bis(fluorosulfonyl)imide was determined by using Metrohm 833 ion chromatograph.

The test results of relevant parameters are shown in Table 1.

### Comparative Example 2

Steps (1) and (2) are as in Comparative Example 1;
(3) 5.0 g of lithium fluoride was added into a reactor, heated to 70° C., and 34.91 g of the bis(fluorosulfonyl)imide obtained in step (2) was slowly added dropwise. After reacting for 12 h, nitrogen was blown into the reactor for 1 h, the temperature was lowered to room temperature, then the reaction product was washed with dichloromethane, the filter cake obtained by filtration was dissolved with diethyl ether, impurities were removed by filtration to obtain a filtrate, which was concentrated to 30% by weight using a rotary evaporator, then the concentrated solution was recrystallized with dimethyl carbonate, and finally dried in vacuum to obtain 30.04 g of lithium bis(fluorosulfonyl)imide. The purity of lithium bis(fluorosulfonyl)imide was determined by using Metrohm 833 ion chromatograph.

sing a rotary evaporator, then the concentrated solution was recrystallized with dimethyl carbonate, and finally dried in vacuum to obtain 30.04 g of lithium bis(fluorosulfonyl)imide. The purity of lithium bis(fluorosulfonyl)imide was determined by using Metrohm 833 ion chromatograph.

The test results of relevant parameters are shown in Table 1.

TABLE 1
Test results of relevant parameters of Examples 1 to 4 and Comparative Examples 1 and 2

| | Example | Example | Example | Example | Comparative | Comparative |
|---|---|---|---|---|---|---|
| | 1 | 2 | 3 | 4 | Example 1 | Example 2 |
| Step (1) Yield | 93.48% | 95.17% | 94.27% | 93.26% | 81.80% | 81.80% |
| Step (2) Yield | 90.38% | 93.34% | 92.45% | 91.20% | 81.12% | 81.12% |
| Step (3) Yield | 83.01% | 88.28% | 85.29% | 83.20% | 88.53% | 83.31% |
| Step (4) Yield | 90.00% | 92.32% | 91.45% | 91.60% | | |
| Total yield of | 84.48% | 88.84% | 87.15% | 85.06% | 81.80% | 81.80% |
| bis(chlorosulfonyl)imide | | | | | | |
| Total yield of lithium | 63.11% | 72.40% | 67.98% | 64.82% | 58.74% | 55.28% |
| bis(fluorosulfonyl)imide | | | | | | |
| Purity | 99.6% | 99.8% | 99.7% | 99.7% | 99.4% | 99.2% |

As can be seen from Table 1, the purity of the examples of the present invention is superior to that of Comparative Examples 1 and 2, the overall yield of Examples 1 to 4 is between 63.11% and 72.4%, which is superior to that of the comparative examples.

In comparison with Example 1, sulfamic acid, chlorosulfonic acid and thionyl chloride to prepare bis(chlorosulfonyl)imide were used in Comparative Example 1, the yield of bis(chlorosulfonyl)imide was 81.8%, which was lower than the overall yield of bis(chlorosulfonyl)imide of Example 1 by 84.48%, thus resulting in an overall yield of lithium bis(fluorosulfonyl)imide also lower than that of Example 1. It can be seen from the synthetic route that using the method of Comparative Example 1 to produce 1 mol of bis(chlorosulfonyl)imide, 2 mol of sulfur dioxide gas, and 3 mol of hydrogen chloride gas while using the method of the present invention to produce only 2 mol of hydrogen chloride gas and 2 mol of sulfur dioxide gas, which reduces the amount of waste gas produced, and the raw materials of the present invention are simple, the preparation cost is low, the corrosion is small and the environmental impact is small. Impurities such as lithium fluorosulfonate may remain in Comparative Example 1, resulting in a decrease in purity.

ur dioxide gas, and 3 mol of hydrogen chloride gas while using the method of the present invention to produce only 2 mol of hydrogen chloride gas and 2 mol of sulfur dioxide gas, which reduces the amount of waste gas produced, and the raw materials of the present invention are simple, the preparation cost is low, the corrosion is small and the environmental impact is small. Impurities such as lithium fluorosulfonate may remain in Comparative Example 1, resulting in a decrease in purity.

Bis(chlorosulfonyl)imide was prepared by using sulfamic acid, chlorosulfonic acid, and thionyl chloride in Comparative Example 2, and lithium bis(fluorosulfonyl)imide was synthesized using a process of low reaction temperature and long reaction time with lower yield and purity.

In summary, in the present invention, iminodisulfonic acid is prepared using sulfur trioxide and ammonia as raw materials, bis(chlorosulfonyl)imide is obtained by chlorination using thionyl chloride, and then lithium bis(fluorosulfonyl)imide is prepared by fluorination and lithiation in sequence. The raw materials used are simple and the production cost is low; the production of three wastes is less and the process is environmentally friendly; which has less side reactions, excellent yield, and high purity, and can meet the requirements of yield and quality for large-scale industrial production.

The foregoing is illustrative of the preferred embodiments of the present invention and is not to be construed as limiting the invention in any way. All changes, equivalents, and improvements that come within the spirit and scope of the invention are desired to be included therein.

1. A preparation method for lithium difluorophosphate, characterized by comprising the following steps of:
(1) stirring and reacting lithium hexafluorophosphate with silicon tetrachloride in a first non-aqueous solvent under substantially anhydrous conditions, and degassing and removing impurities to obtain a lithium difluorotetrachloro phosphate solution;
(2) dropwise adding the obtained lithium difluorotetrachloro phosphate solution into a lithium carbonate dispersion for reaction, and filtering to obtain a filter cake mixture of lithium difluorophosphate and lithium chloride; and
(3) pulping the filter cake mixture with ethyl acetate, filtering to remove insoluble material, concentrating the pulping solution, and crystallizing by adding a non-polar solvent to obtain lithium difluorophosphate.

2. The preparation method for lithium difluorophosphate according to claim 1, characterized in that the charge molar ratio of lithium hexafluorophosphate, silicon tetrachloride, and lithium carbonate is 1:(1-1.5):(2-2.5).

3. The preparation method for lithium difluorophosphate according to claim 1, characterized in that in step (1), the molar concentration of lithium hexafluorophosphate is 1.5 to 4.0 mol/L.

4. The preparation method for lithium difluorophosphate according to claim 1, characterized in that
in step (1), reaction temperature of lithium hexafluorophosphate and silicon tetrachloride in the first non-aqueous solvent is 20° C. to 100° C.

5. The preparation method for lithium difluorophosphate according to claim 1, characterized in that
in step (2), the reaction temperature of lithium difluorotetrachloro phosphate and lithium carbonate is 30° C. to 80° C.

6. The preparation method for lithium difluorophosphate according to claim 1, characterized in that the first non-aqueous solvent and the second non-aqueous solvent are each independently one or a combination of two or more selected from the group consisting of a cyclic carbonate, a chain carbonate, and a cyclic ether.

7. The preparation method for lithium difluorophosphate according to claim 1, characterized in that in step (3), the mass ratio of the filter cake mixture to ethyl acetate is 1:(1-2), the filter cake mixture being pulped with ethyl acetate for 3 to 5 h.

8. The preparation method for lithium difluorophosphate according to claim 1, characterized in that
in step (3), the non-polar solvent is one or a combination of two or more selected from the group consisting of n-hexane, n-pentane, cyclohexane, heptane, dichloromethane, trichloromethane, and 1,2-dichloroethane.

9. The preparation method for lithium difluorophosphate according to claim 1, characterized in that in step (3), the temperature for crystallization is 0° C. to 5° C.

10. The preparation method for lithium difluorophosphate according to claim 1, characterized in that in step (3), after crystallization, filtration is also performed to obtain a filter cake, and the filter cake is dried to obtain lithium difluorophosphate at a temperature of 80° C. to 120° C.

11. The preparation method for lithium difluorophosphate according to claim 1, characterized in that in both step (1) and step (2), the reaction is carried out in an atmosphere of inert gas, wherein the inert gas is one or more gases selected from the group consisting of nitrogen, argon, and helium.

12. A lithium difluorophosphate prepared by the preparation method according to claim 1, characterized in that the lithium difluorophosphate has a purity of ≥99.8% and a free acid content of ≤50 ppm.

13. The lithium difluorophosphate according to claim 12, characterized by having a moisture content of ≤10 ppm, a Cl⁻ content of ≤1 ppm, the sum of the content of impurity metal ions of ≤2 ppm.

14. A non-aqueous electrolyte battery characterized by comprising a positive electrode, a negative electrode, and an electrolyte comprising the lithium difluorophosphate of claim 12.

15. (canceled)

16. The preparation method for lithium difluorophosphate according to claim 1, characterized in that in step (1), the gas used in the degassing and removing impurities is a non-reactive gas, and the temperature of the degassing and impurity removal is 60° C. to 120° C.

17. The preparation method for lithium difluorophosphate according to claim 16, characterized in that the non-reactive gas is one or more gases selected from the group consisting of nitrogen, argon, helium, and combination thereof.

18. The preparation method for lithium difluorophosphate according to claim 1, characterized in that in step (2), preparing a lithium carbonate dispersion by mixing lithium carbonate with a second non-aqueous solvent, wherein the mass ratio of lithium carbonate to the second non-aqueous solvent is between 1:3 and 1:5.

19. The preparation method for lithium difluorophosphate according to claim 1, characterized in that in step (3), the concentrating pulping solution is carried out by subjecting the filtrate to vacuum distillation at a temperature of 40° C. to 80° C.

20. The lithium difluorophosphate according to claim 12, wherein the lithium difluorophosphate has a free acid content of ≤25 ppm.

21. The lithium difluorophosphate according to claim 13, characterized by having a Cl⁻ content of ≤0.8 ppm, the sum of the content of impurity metal ions of ≤1.5 ppm.
